(19) United States
(12) Patent Application Publication
(10) Pub. No.: US 2019/0042162 A1
(43) Pub. Date: Feb. 7, 2019

(54) BACK-END MEMORY CHANNEL THAT RESIDES BETWEEN FIRST AND SECOND DIMM SLOTS AND APPLICATIONS THEREOF

(71) Applicant: Intel Corporation, Santa Clara, CA (US)

(72) Inventors: James A. McCALL, Portland, OR (US); Suneeta SAH, Portland, OR (US); George VERGIS, Portland, OR (US); Dimitrios ZIAKAS, Hillsboro, OR (US); Bill NALE, Livermore, CA (US); Chong J. ZHAO, West Linn, OR (US); Rajat AGARWAL, Portland, OR (US)

(73) Assignee: Intel Corporationn, Santa Clara, CA (US)

(21) Appl. No.: 16/104,040

(22) Filed: Aug. 16, 2018

(51) Int. Cl. G06F 3/06

(52) U.S. Cl. CPC G06F 3/0679; G06F 3/0638; G06F 3/0604

(57) ABSTRACT

A computing system is described. The computing system includes a memory controller having a double data rate memory interface. The double data rate memory interface has a first memory channel interface and a second memory channel interface. The computing system also includes a first DIMM slot and a second DIMM slot. The computing system also includes a first memory channel coupled to the first memory channel interface and the first DIMM slot, wherein the first memory channel's CA and DQ wires are not coupled to the second DIMM slot. The computing system also includes a second memory channel coupled to the second memory channel interface and the second DIMM slot, wherein the second memory channel's CA and DQ wires are not coupled to the first DIMM slot. The computing system also includes a back end memory channel that is coupled to the first and second DIMM slots.

### FIELD OF INVENTION

The field of invention pertains generally to the computing sciences, and, more specifically, to a back-end memory channel that resides between first and second DIMM slots and applications thereof.

### BACKGROUND

The performance of computing systems is highly dependent on the performance of their system memory. Generally, however, increasing memory channel capacity and memory speed can result in challenges concerning the power consumption of the memory channel implementation. As such, system designers are seeking ways to increase memory channel capacity and bandwidth while keeping power consumption in check.

### FIGURES

A better understanding of the present invention can be obtained from the following detailed description in conjunction with the following drawings, in which:

FIG. 1 depicts a first prior art DIMM;

FIG. 2 depicts a second prior art DIMM;

FIG. 3a depicts a third prior art DIMM;

FIG. 3b depicts a prior art memory channel;

FIG. 4 depicts a DDR5 memory channel interface with corresponding DIMM slot memory channel wiring;

FIG. 5a depicts improved DIMM slot memory channel wiring;

FIG. 5b depicts a first DIMM for use in the improved DIMM slot memory wiring of FIG. 5a;

FIG. 6 depicts a first configuration for the improved DIMM slot memory wiring of FIG. 5a;

FIG. 7 depicts a second configuration for the improved DIMM slot memory wiring of FIG. 5a;

FIG. 8a shows a second DIMM for use in the improved DIMM slot memory wiring of FIG. 5a;

FIG. 8b shows a third configuration for the improved DIMM slot memory wiring of FIG. 5a;

FIG. 9 shows a computing system.

### DETAILED DESCRIPTION

As is known in the art, main memory (also referred to as “system memory”) in high performance computing systems, such as high performance servers, are often implemented with dual in-line memory modules (DIMMs) that plug into a memory channel. Here, multiple memory channels emanate from a main memory controller and one or more DIMMs are plugged into each memory channel. Each DIMM includes a number of memory chips that define the DIMM's memory storage capacity. The combined memory capacity of the DIMMs that are plugged into the memory controller's memory channels corresponds to the system memory capacity of the system.

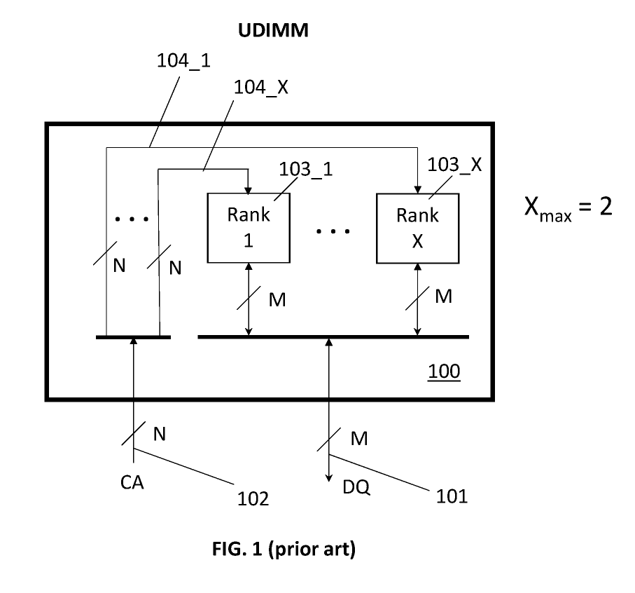

Over time the design and structure of DIMMs has changed to meet the ever increasing need of both memory capacity and memory channel bandwidth. FIG. 1 shows a traditional DIMM approach. As observed in FIG. 1, a single “unbuffered” DIMM (UDIMM) 100 has its memory chips directly coupled to the wires of the memory channel bus 101, 102. The UDIMM 100 includes a number of memory chips sufficient to form a data width of at least one rank 103. A rank corresponds to the width of the data bus which generally corresponds to the number of data signals and the number of ECC signals on the memory channel.

As such, the total number of memory chips used on a DIMM is a function of the rank size and the bit width of the memory chips. For example, for a rank having 64 bits of data and 8 bits of ECC, the DIMM can include eighteen “×4” (four bit width) memory chips (e.g., 16 chips×4 bits/chip=64 bits of data plus 2 chips×4 bits/chip to implement 8 bits of ECC), or, nine “×8” (eight bit width) memory chips (e.g., 8 chips×8 bits/chip=64 bits of data plus 1 chip×8 bits/chip to implement 8 bits of ECC).

For simplicity, when referring to FIG. 1 and the ensuing figures, the ECC bits may be ignored and the observed rank width M simply corresponds to the number of data bits on the memory bus. That is, e.g., for a data bus having 64 data bits, the rank=M=64.

UDIMMs traditionally only have storage capacity for two separate ranks of memory chips, where, one side of the DIMM has the memory chips for a first rank and the other side of the DIMM has the memory chips for a second rank. Here, a memory chip has a certain amount of storage space which correlates with the total number of different addresses that can be provided to the memory chip. A memory structure composed of the appropriate number of memory chips to interface with the data bus width (eighteen×4 memory chips or nine×8 memory chips in the aforementioned example) corresponds to a rank of memory chips. A rank of memory chips can therefore separately store a number of transfers from the data bus consistently with its address space. For example, if a rank of memory chips is implemented with memory chips that support 256M different addresses, the rank of memory chips can store the information of 256M different bus transfers.

Notably, the memory chips used to implement both ranks of memory chips are coupled to the memory channel 101, 102 in a multi-drop fashion. As such, the UDIMM 100 can present as much as two memory chips of load to each wire of the memory channel data bus 101 (one memory chip load for each rank of memory chips).

Similarly, the command and address signals for both ranks of memory chips are coupled to the memory channel's command address (CA) bus 102 in multi-drop form. The control signals that are carried on the CA bus 102 include, to name a few, a row address strobe signal (RAS), column address strobe signal (CAS), a write enable (WE) signal and a plurality of address (ADDR) signals. Some of the signals on the CA bus 102 typically have stringent timing margins. As such, if more than one DIMM is plugged into a memory channel, the loading that is presented on the CA bus 102 can sufficiently disturb the quality of the CA signals and limit the memory channel's performance.

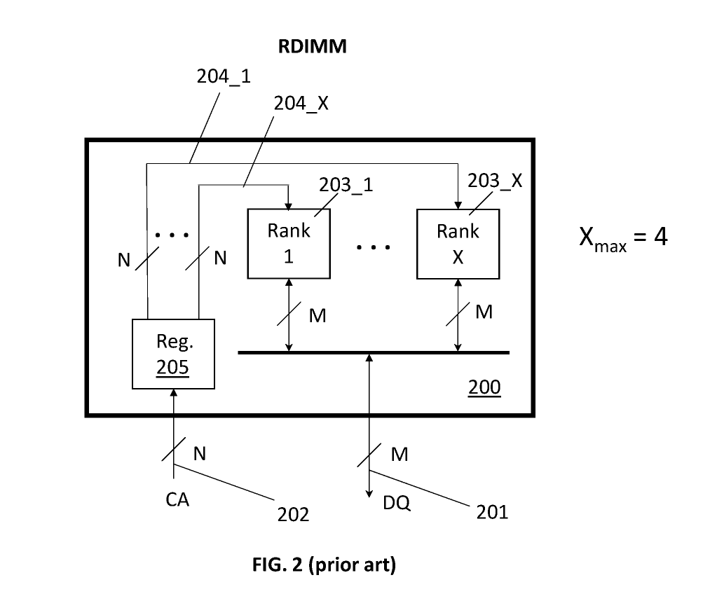

FIG. 2 shows a later generation DIMM, referred to as a register DIMM 200 (RDIMM), that includes register and redrive circuitry 205 to address the aforementioned limit on memory channel performance presented by loading of the CA bus 202. Here, the register and redrive circuitry 205 acts as a single load per DIMM on each CA bus 202 wire as opposed to one load per rank of memory chips (as with the UDIMM). As such, whereas a nominal dual rank UDIMM will present one load on each wire of the memory channel's CA bus 202 for each memory chip on the UDIMM (because each memory chip on the UDIMM is wired to the CA bus 202), by contrast, a dual rank RDIMM with an identical set of memory chips, etc. will present only one chip load on each of the memory channel's CA bus 202 wires.

In operation, the register and redrive circuitry 205 latches and/or redrives the CA signals from the memory channel's CA bus 202 to the memory chips of the particular rank of memory chips on the DIMM that the CA signals are specifically being sent to. Here, for each memory access (read or write access with corresponding address) that is issued on the memory channel, the corresponding set of CA signals include chip select signals (CS) and/or other signals that specifically identify not only a particular DIMM on the channel but also a particular rank on the identified DIMM that is targeted by the access. The register and redrive circuitry 205 therefore includes logic circuitry that monitors these signals and recognizes when its corresponding DIMM is being accessed. When the logic circuitry recognizes that its DIMM is being targeted, the logic further resolves the CA signals to identify a particular rank of memory chips on the DIMM that is being targeted by the access. The register and redrive circuitry then effectively routes the CA signals that are on the memory channel to the memory chips of the specific targeted rank of memory chips on the DIMM 200.

A problem with the RDIMM 200, however, is that the signal wires for the memory channel's data bus 201 (DQ) are also coupled to the DIMM's ranks of memory chips 203_1 through 203_X in a multi-drop form. That is, for each rank of memory chips that is disposed on the RDIMM, the RDIMM will present one memory chip load on each DQ signal wire. Thus, similar to the UDIMM, the number of ranks of memory chips that can be disposed on an RDIMM is traditionally limited (e.g., to two ranks of memory chips) to keep the loading on the memory channel data bus 201 per RDIMM in check.

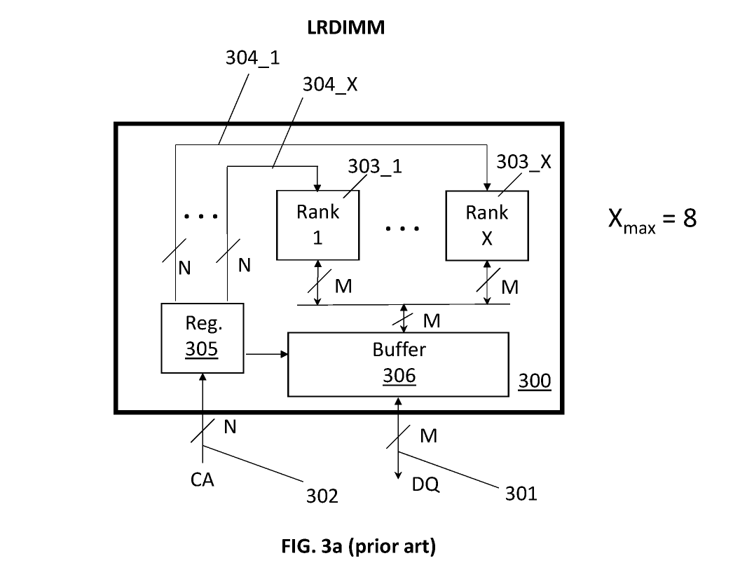

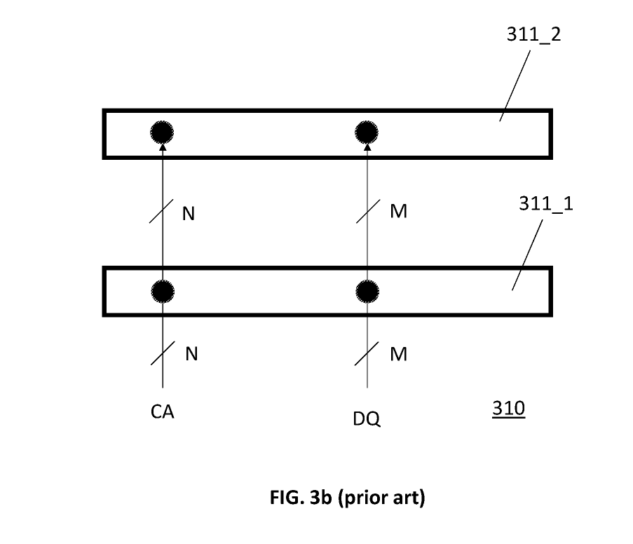

FIG. 3a shows an even later generation DIMM, referred to as a load reduced DIMM (LRDIMM) 300, in which both the CA bus wires 302 and the DQ bus wires 301 are presented with only a single load by the LRDIMM 300. Here, similar to the register and redrive circuitry of the RDIMM, the LRDIMM includes buffer circuitry 306 that stores and forwards data that is to be passed between the memory channel data bus 301 and the particular rank of memory chips 303 that is being targeted by an access. The register and redrive circuitry 305 activates whichever rank of memory chips is targeted by a particular access and the data associated with that access appears at the “back side” of the buffer circuitry 306.

With only a single point load for both the DQ and CA wires 301, 302 on the memory channel, the memory capacity of the LRDIMM 300 is free to expand its memory storage capacity beyond only two ranks of memory chips (e.g. four ranks on a single DDR4 DIMM). With more ranks of memory chips per DIMM and/or a generalized insensitivity to the number of memory chips per DIMM (at least from a signal loading perspective), new memory chip packaging technologies that strive to pack more chips into a volume of space have received heightened attention is recent years. For example, stacked chip packaging solutions can be integrated on an LRDIMM to form, e.g., a 3 Dimensional Stacking (3DS) LRDIMM.

Even with memory capacity per DIMM being greatly expanded with the emergence of LRDIMMs, memory channel bandwidth remains limited with LRDIMMs because multiple LRDIMMs can plug into a same memory channel. That is, a multi-drop approach still exists on the memory channel in that more than one DIMM can couple to the CA and DQ wires of a same memory channel.

Here, FIG. 3b shows a high performance memory channel layout 310 in which two DIMM slots 311_1, 311_2 are coupled to a same memory channel. The particular layout of FIG. 3b is consistent with the Joint Electron Device Engineering Council (JEDEC) Double Date Rate 4 (DDR4) memory standard. As can be seen from the layout 310 of FIG. 3b, if a respective LRDIMM is plugged into each of the two slots 311_1, 311_2, each CA bus wire and DQ bus wire will have two loads (one from each LRDIMM). If the loading could be further reduced, the timing margins of the CA and DQ signals could likewise be increased, which, in turn, would provide higher memory channel frequencies and corresponding memory channel bandwidth (read/write operations could be performed in less time).

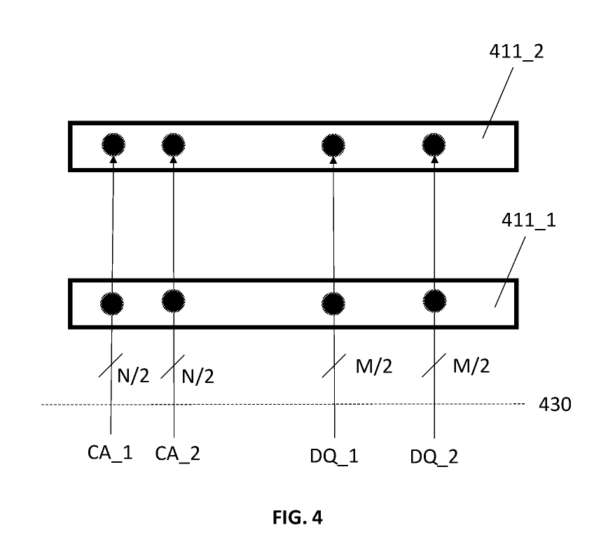

A next generation JEDEC memory interface standard, referred to as DDR5, is taking the approach of physically splitting both the CA bus and the DQ bus into two separate multi-drop busses as depicted in FIG. 4. Here, comparing FIG. 3b with FIG. 4, note that whereas the layout of FIG. 3b depicts a single N bit wide CA bus that is multi-dropped to two DIMM slots 311_1, 311_2 and a single M bit wide DQ data bus that is also multi-dropped to the two DIMM slots 311_1, 311_2; by contrast, the DDR5 layout of FIG. 4 consists of two separate N/2 bit wide CA busses that are multi-dropped to two DIMM slots 411_1, 411_2 and two separate M/2 bit wide DQ data busses that are multi-dropped to the DIMM slots 411_1, 411_2.

Again, for simplicity, ECC bits are ignored and M=64 in both FIGS. 3b and 4 for DDR4 and DDR5 implementations, respectively. As such, whereas DDR4 has a single 64 bit wide data bus, by contrast, DDR5 has two 32 bit wide data busses (DQ_1 and DQ_2). A “rank” in a DDR5 system therefore corresponds to 32 bits and not 64 bits (the width of both the DQ_1 and DQ_2 data busses is M/2=64/2=32 bits). Likewise, a rank of memory chips for a DDR5 system accepts 32 bits of data from a sub-channel in a single transfer rather than 64 as in DDR4.

A concern, however, is that the JEDEC DDR5 layout of FIG. 4 still adopts a multi-drop bus approach. That is both pairs of CA and DQ busses, as observed in FIG. 4, multi-drop to both DIMM slots 411_1, 411_2. With both the CA and DQ busses adopting a multi-drop approach, there is no fundamental increase in operating frequency of the channel nor corresponding increase in data rate of the DDR5 memory channel as compared to the earlier channel of FIG. 3b. That is, in terms of data rate, the physical layout of FIG. 4 will generally possess the same physical limitations as the earlier generation memory channel of FIG. 3b.

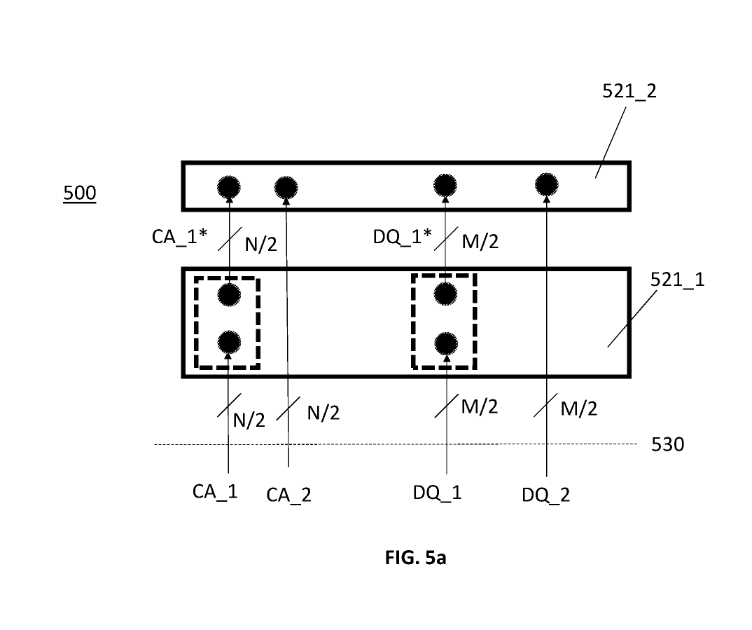

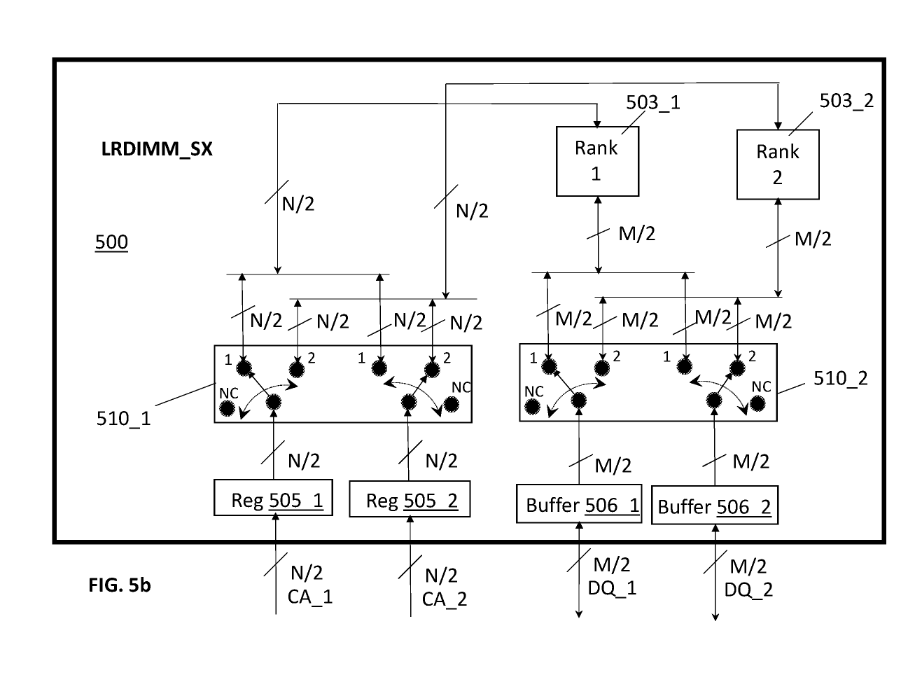

FIG. 5a therefore shows an improved memory channel approach that conforms to the DDR5 host side interface 530 (at least in terms of CA and DQ bus wire-count, pin-out and/or signaling) but in which the different DIMMs do not couple to the interface 430 in a multi-drop fashion. Instead, comparing FIG. 4 and FIG. 5a, both the DQ1 and DQ2 data busses and the CA_1 and CA_2 control channels are implemented as point-to-point links. The use of point-to-point links reduces the capacitive loading by one less DIMM for each of the DQ busses and CA channels as compared to the official DDR5 approach of FIG. 4 which, in turn, allows for higher clock speeds and corresponding transfer rates with the approach of FIG. 5a than the official DDR5 approach of FIG. 4.

As observed in FIG. 5a, the CA_2 control channel and the DQ_2 data bus are wired directly from the host (which resides “beneath” interface 530 in FIG. 5a) to the “farther” DIMM slot 5212. The “closer” DIMM slot 521_1 is not connected to either the CA_2 control channel or the DC₁₋₂ data bus in order to reduce their respective capacitive loads. Likewise, the CA_1 control channel and the DQ_1 data bus are wired directly from the host to the closer DIMM slot 521_1. The farther DIMM slot 521_1 is not connected to either the CA_1 control channel or the DQ_1 data bus in order to reduce their respective capacitive loads.

The layout of FIG. 5a also includes a point-to-point “back end” control channel CA_1* and DQ_1* bus between the closer DIMM slot 521_1 and the farther DIMM slot 5212. As will be described in more detail below, the back end wiring CA_1*, DQ_1* can be used in configurations where the DIMM or other card/module that is plugged into the closer DIMM slot 521_1 does not process some or all signals that are directed over the CA_1 channel and DQ_1 bus and redrives them to a DIMM that is plugged into the farther DIMM slot 521_2.

FIG. 5b shows a DIMM 500 that is designed to plug into either of the DIMM slots 521_1, 521_2 of FIG. 5a. FIG. 5a shows a dual rank DIMM having first and second ranks 503_1, 503_2. The DIMM is designed as an LR DIMM having buffers 506_1, 506_2 for both DQ_1 and DQ_2 data busses and register redriver circuits 505_1, 505_2 for both CA_1 and CA_2 control channels.

Switch circuits 510_1, 510_2 reside between the memory ranks 503 and the register redriver 505 and buffer 506 circuits. The switch circuits 510_1, 510_2 are configured to maintain or dynamically switch between switch states in a manner that takes into account the point-to-point link structure of the layout between the DIMM slots and the host and maximizes or at least expands the available memory capacity of both the CA_1/DQ_1 and CA_2/DQ_2 memory channels for a particular DIMM population scheme into the DIMM slot layout structure.

As can be seen in FIG. 5b, both switches have first and second primary states. A first state (“1”) in which CA/DQ signals are sent to the first rank 503_1 and a second state (“2”) in which the CA/DQ signals are sent to the second rank 503_2. Both switches have a left half and a right half. Left half switches switch signals received from a first CA channel or DQ bus (the left half of switch 510_1 switches CA_1 signals, the left half of switch 510_2 switches DQ_1 signals). Right half switches switch signals received from a second CA channel or DQ bus (the left half of switch 510_2 switches CA_2 signals, the left half of switch 510_2 switches DQ_2 signals). As will be more apparent in the following discussion, even though in certain deployments one of the CA channels and DQ busses is not available because of the point-to-point link nature of the layout, the switches nevertheless make it possible for both ranks to be reached irrespective of which memory channel the DIMM is in physical contact with.

In various embodiments the CA switches 510_1 may not exist. However, the remainder of the document is written with their presence being assumed.

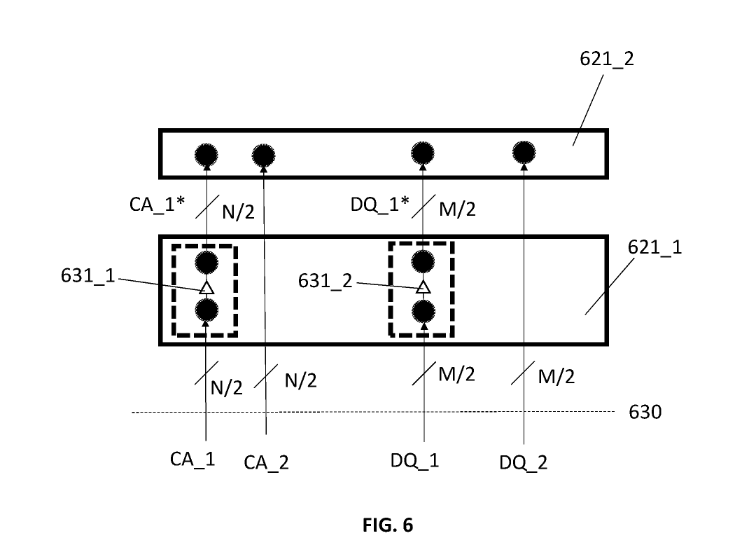

FIG. 6 shows a first DIMM population scheme in which only one DIMM is plugged into the memory subsystem in the farthest DIMM slot 621_2. Here, the DIMM that is plugged into DIMM slot 621_2 may be a DIMM designed the same as or similarly to the DIMM 500 of FIG. 5b. A “dummy” card (more generally, “module”) is also plugged into the closest DIMM slot 621_1 whose primary electric components include re-driver circuits 631_1, 631_2 that couple the CA_1 channel to the back-end CA_1* channel and the DQ1 bus to the back-end DQ1* bus. As such, signals on the CA_1 channel and the DQ_1 bus are passed between the host and the farthest DIMM slot 621_2 even though the farthest DIMM slot 621_2 has been wired only to directly receive the second memory channel (CA_2 and DQ_2).

Referring to FIG. 5b, the DIMM that is plugged into the farthest slot 621_2 will have the left side switch of CA switches 510_1 configured to remain in switch state 1 so that CA signals received on the CA_1* back-end channel will be routed to the first rank 503_1. Likewise, the left side switch of DQ switches 510_2 will be configured to remain in switch state so that DQ signals received on the DQ_1* back-end bus will also be routed to the first rank 503_1. By contrast, the right side switch of CA switches 510_1 will be configured to remain in switch state 2 so that CA signals received on the CA_2 channel will be routed to the second rank 503_2. Likewise, the right side switch of DQ switches 510_2 is configured to remain in switch state 2 so that DQ signals received on the DQ_2 bus will also be routed to the second rank 503_2. With the aforementioned switch settings the CA_1 channel and DQ_1 bus will couple the host with the first rank 503_1 and CA_1 channel and DQ_2 bus will couple the host with the second rank 503_2.

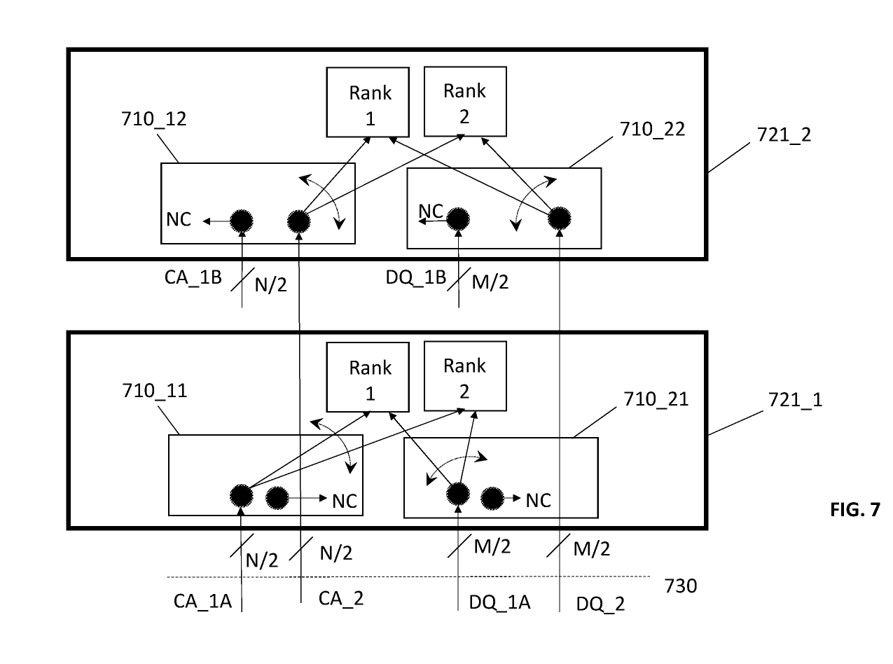

FIG. 7 shows another DIMM configuration in which a first DIMM like the DIMM of FIG. 5b is plugged into the closer DIMM slot 721_1 and a second DIMM like the DIMM of FIG. 5b is plugged into the farther DIMM slot 721_2. As depicted in FIG. 7, the left side switches of the switch circuits 710_{—} 11, 710_21 of the DIMM in the closer slot 721_2 are configured to receive CA_1 and DQ_1 signals from the host and dynamically switch coupling between the host and both ranks (rank_1 and rank_2) on the DIMM. Here, a CA signal on the CA_1 channel, such as chip select (CS) signal, can be sent by the host to inform the DIMM in the closer slot 721_1 which of the two ranks on the DIMM is being targeted by any particular access. The left side switches then dynamically switch in response to the correct position to connect to the targeted rank. The right side switches are disabled (set to no connection (NC)). However, this setting is a formality because, as discussed above, a physical connection between the CA_2 channel and the DQ₁₋₂ bus and the closer slot 721_1 does not exist (the CA_2 channel and DQ₁₋₂ bus are implemented as a point-to-point link to the farthest slot 721_2).

With respect to the DIMM that is plugged into the farthest slot 721_2, the right side switches of the switch circuits 710_12, 710_22 are configured to receive CA_2 and DQ_2 signals from the host and dynamically switch coupling between the host and both ranks (rank_1 and rank_2) on the DIMM. Here, a CA signal on the CA_2 channel, such as chip select (CS) signal, can be sent by the host to inform the DIMM in the farther slot 721_2 which of the two ranks on the DIMM is being targeted by any particular access. The right side switches then switch to the correct position to dynamically connect to the targeted rank in response. The left side switches are disabled (set to no connection (NC)). However, this setting is a formality because, as discussed above, a physical connection between the CA_1 channel and the DQ_1 bus and the farther slot 721_1 does not exist (the CA_1 channel and DQ_1 bus are implemented as a point-to-point link to the closest slot 721_1). Here, the back-end CA_1* channel and back-end DQ_1* bus are dormant (unused) because the DIMM in the first slot 721_1 does not redrive any signals on them.

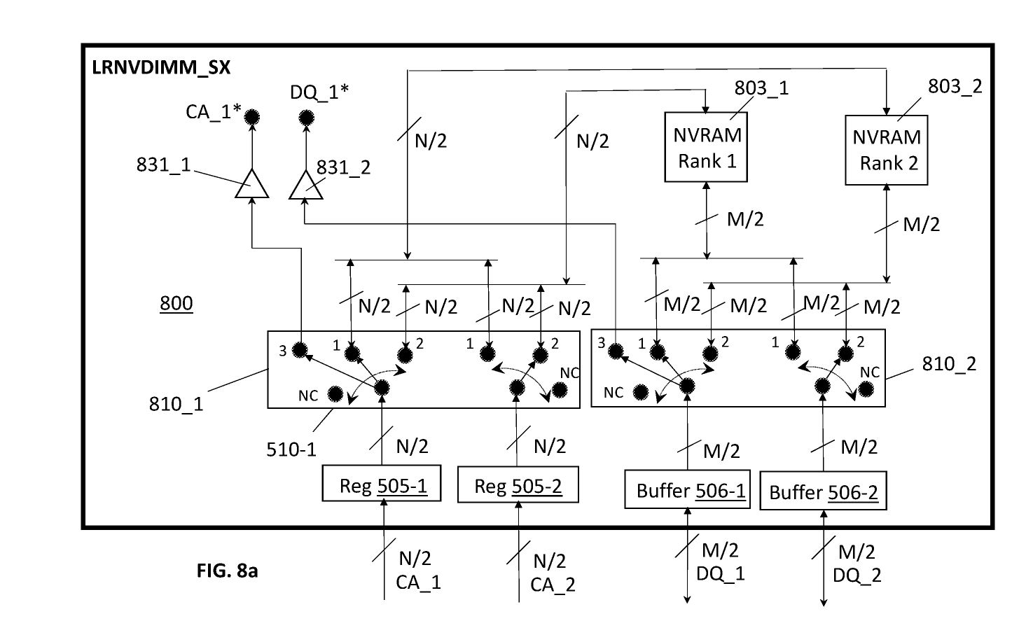

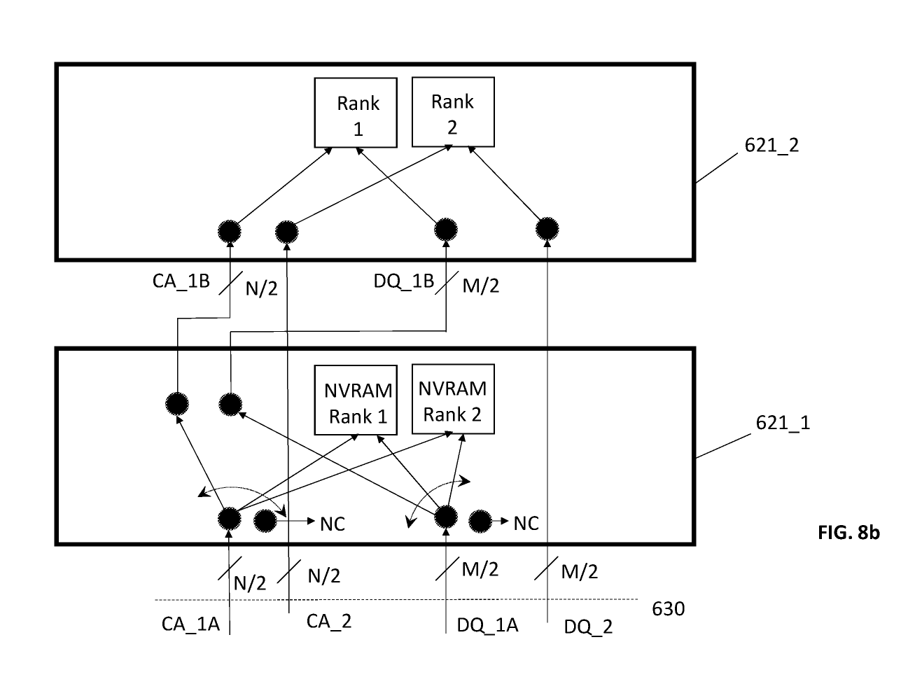

FIG. 8a shows another DIMM 800 whose ranks are composed of non volatile random access memory (NVRAM). In various embodiments, the NVRAM can be flash memory, or, an emerging non volatile random access memory. Possible technologies for NVRAM include phase change based memory, memory devices having storage cells composed of chalcogenide, a ferro-electric based memory (e.g., FeRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, “3D Xpoint” or “Optane” memory from Intel, Corp., etc.

NVRAM technology may also manufacture a storage cell array as a three dimensional storage cell array, e.g., in the metallurgy above the semiconductor chip substrate, rather than as two dimensional array where the storage cells are embedded in the surface of the semiconductor chip substrate. Storage cells in the three dimensional storage cell array may also be accessed according to a cross-point physical access mechanism (e.g., a targeted cell resides between a pair of orthogonally oriented access wires in the chip's metallurgy).

Importantly, NVRAM may operate significantly faster than traditional non volatile mass storage devices and/or support finer access granularities than traditional non volatile mass storage devices (which can only be accessed in “pages”, “sectors” or “blocks” of data). With the emergence of NVRAM, traditional non volatile access/usage paradigms may be obviated/lessened in favor of new kinds of non volatile usage/access paradigms that treat non volatile resources more as a true random access memory than a traditional mass storage device.

Some possible examples include: 1) execution of byte addressable non volatile memory read and/or write instructions and/or commands; 2) physically accessing non volatile memory data at CPU cache line granularity; 3) operating software directly out of non volatile memory which behaves as true system memory or main memory (e.g., software main memory access read/write instructions executed by a CPU are completed directly at NVRAM rather than only at non volatile DRAM); 4) assignment of system/main memory address space to non volatile memory resources; 5) elimination and/or reduction of movement of “pages” of data between main memory and traditional mass storage device(s); 6) “commitment” of data as a mechanism of preserving the data (such as traditional database algorithms (e.g., two-phase commit protocol)) to NVRAM system memory rather than a traditional non volatile mass storage device; 7) accessing non volatile memory from a main memory controller rather than through a peripheral control hub; 8) existence of a multi-level system/main memory where the different levels have different access timing characteristics (e.g., a faster, “near memory” level composed of DRAM and slower “far memory” level composed of NVRAM); 9) existence of a “memory-side” cache at the front end of system/main memory (e.g., composed of DRAM) that caches the system/main memory's most requested items including items requested by components other than a CPU such as a display, peripheral, network interface, etc.

With respect to 8) and 9) above, in various embodiments, the NVRAM DIMM 800 of FIG. 8a is plugged into one of the DIMM slots (e.g., the closer DIMM slot) and a DRAM DIMM is plugged into the other DIMM slot (e.g., the farther DIMM slot). Here, the DRAM DIMM may act as a memory side cache for the NVRAM DIMM as a form of multi-level system memory implementation. Alternatively the DRAM DIMM may be allocated its own unique (e.g., higher priority) memory address space. Further still, in other embodiments, the DRAM DIMM may have some of its memory resources allocated as a memory side cache and other memory resources allocated as its own unique system memory address space.

According to the basic operation of the NVRAM DIMM 800 of FIG. 8a, the state of the switches of the DIMM 800 will be the same as described above for a configuration like that of FIG. 6 (the NVRAM DIMM is plugged into the farthest slot and a dummy re-driver module is plugged into the closer slot). Likewise, the state and operation (dynamic switching) of the switches of the DIMM 800 will be the same as described above for a configuration like that of FIG. 7 (both closer and farther DIMMs have an NVRAM plugged into them).

Importantly, generally, flash or emerging NVRAM technologies are understood to be slower than dynamic random access memory (DRAM) and/or have non deterministic response timing(s). With the ranks of the DIMM of FIG. 5 understood to be composed of DRAM, the DIMM 800 of FIG. 8a would generally not be able to support the data rates in/out of memory as the DIMM 500 of FIG. 5 is able to support. That is, with NVRAM being slower than DRAM and/or having non-deterministic access times (DRAM has deterministic access times), the CA and DQ bus that is coupled to an NVRAM DIMM is apt to have some quiet, unused windows of time as compared to a DRAM DIMM.

As such, the NVRAM DIMM 800 of FIG. 8a also includes an additional switch state (switch state “3”) for the left side switches of switch circuits 810_1, 810_2 that enables coupling to re-drivers 831_1, 831_2 that redrive CA_1 and DQ_1 signals onto the back-end CA_1* channel and the back-end DQ_1* bus. Here, when the host is stalled from sending signals to the NVRAM DIMM over the CA_1 channel and DQ_1 bus because of its overall slowness, the host can instead direct CA_1 and DQ_1 signals to the DRAM DIMM in the farther slot.

This configuration and operational extension is depicted in FIG. 8b. Here, the left side switches of the switch circuits 810_1, 810_2 of the NVRAM DIMM not only switch dynamically between the first and second NVRAM ranks 803_1, 803_2 on the DIMM 800 but also dynamically switch between a third state (3) that couples the CA_1 channel and DQ_1 bus to their respective back connections CA_1*, DQ_1* to the farthest DIMM. Again, a CA_1 signal sent by the host, such as a chip select (CS) signal, can be used to inform the NVRAM DIMM that is plugged into the closest slot 721_1 whether the target of the access is its first NVRAM rank 803_1, its second NVRAM rank 803_2, or the DIMM in the farthest slot 721_2. In the case of the later, the left side switches will connect to the redrivers 831_1, 831_2.

Thus, the memory controller may be designed with special logic circuitry that opportunistically accesses, e.g., a DRAM DIMM in the farthest slot over the memory channel that is nominally dedicated, e.g., to an NVRAM DIMM in the nearer slot when the relative slowness of the NVRAM DIMM results in available time windows on the memory channel that is coupled to the nearer slot. Here, the memory controller may contain state tracking information that tracks the state of the NVRAM DIMM so the memory controller can readily recognize when such available time window occur. For example the memory controller may understand the state of a write queue on the NVRAM DIMM and be able to recognize when the NVRAM is not able to entertain any more write commands because the write queue is full. Additionally the NVRAM DIMM may be designed to support a transactional read request protocol in which the NVRAM DIMM initiates communication with the memory controller when it has a read response ready to send to the memory controller. Here, for example, if the special logic circuitry of the memory controller recognizes that the NVRAM DIMM's write request is full and the NVRAM DIMM has not initiated any read response activity, the memory controller will recognize that the memory channel that is coupled to the NVRAM DIMM is idle and can presently be used for an access to the DRAM DIMM.

As depicted in FIG. 8b, the switches on the farthest DIMM are hard set such that signals received on the back-end CA_1* channel and back-end DQ_1* bus are always directed to rank_1 on the farthest DIMM and signals received on the CA_2 channel and DQ_2 bus are always directed to the second rank. In another embodiment, the switches may dynamically switch between ranks. The host, however, has to ensure that accesses made across the two different memory channels do not conflict. That is, different accesses to a same rank on the farthest DIMM can not be made simultaneously over the different CA_1/DQ_1 and CA_2/DQ_2 memory channel. As such, the memory controller may be designed to include special circuitry that prevents simultaneous accesses on two different memory channels that target a same rank on a same DIMM.

Note that in various embodiments a memory controller chip may be resident on the NVRAM DIMM 800 of FIG. 8b. For ease of drawing the memory controller chip has not been shown. If such a memory controller chip exists the switch outputs will be directed to the memory controller rather than the NVRAM chips directly. Here, the memory controller chip may implement the aforementioned write request buffer and transactional read response protocol. The memory controller chip in various implementations is positioned between the switch circuits 810 and the actual memory chips 803 (the memory controller chip intercepts communications between the switches and memory chips).

Although the DIMM embodiments described above with respect to FIGS. 5b and 8a were limited to only two ranks per DIMM, in other embodiments, more than two ranks may be resident on the DIMM. For example, DIMMs having four ranks may be implemented, where, e.g., rank 1 and rank 3 (not shown in FIG. 5b/8b) are serviced from the CA_1 channel and the DQ_1 bus, and, rank 2 and rank 4 (not shown in FIG. 5b/8b) are serviced from the CA_2 channel and the DQ_2 bus. In this case, both the left side and right side switches of both switch circuits 510_1/810_1, 510_2/810_2 have an additional switch state to connect to their respective additional rank (left side switches have an extra state to connect to rank 3 and right side switches have an extra state to connect to rank 4).

The switches may also dynamically switch between their two states that respectively connect to their first and second ranks. Here, the CA signals, e.g., a chip select value (CS) may be used by the switches to determine which of their ranks is being targeted, which, in turn, determines which respective switch state they are to switch to.

For illustrative ease neither the DIMM of FIG. 5b nor the DIMM FIG. 8a depict coupling between the register re-driver circuits and the switch circuits. In order to effect dynamic switching as described in any of the above preceding embodiments, however, electronic signals would be sent over control signal lines between the register re-driver circuits and the switch circuits so that the switches can be placed in the correct state based on the control signals received over the CA channel. As such register re-driver circuits 505_1/805_1 would be coupled to switch circuits 510_1/810_1 and register re-driver circuits 505_2/805_2 would be coupled to switch circuits 510_2/810_2.

The ranks of any of the DIMMs described above with respect to FIG. 5b and FIG. 8a may be implemented in various forms of packaged memory, e.g., ×4 packaged memory chips, ×8 packaged memory chips, stacked memory chip solutions, etc.

The switch circuits 510, 810 may also be implemented in various ways in any of the DIMM embodiments described above with respect to FIGS. 5a and 8b. In particular, transistor (e.g., FET) and/or other form of analog switches may be used. Alternatively the switching functions may be performed in logic circuitry such as with multiplexer and/or demultiplexer circuitry. In the case where logic circuitry is used to effect the switches, there should generally be an inbound logic path (e.g., a demultimplexer) to handle write traffic headed toward memory and an outbound logic path (e.g., a multiplexer) to handle read data headed toward the host.

In other embodiments a hybrid DIMM may be constructed where DRAM and NVRAM exist on the same DIMM. For example a first rank may be composed of DRAM and a second rank may be composed of NVRAM.

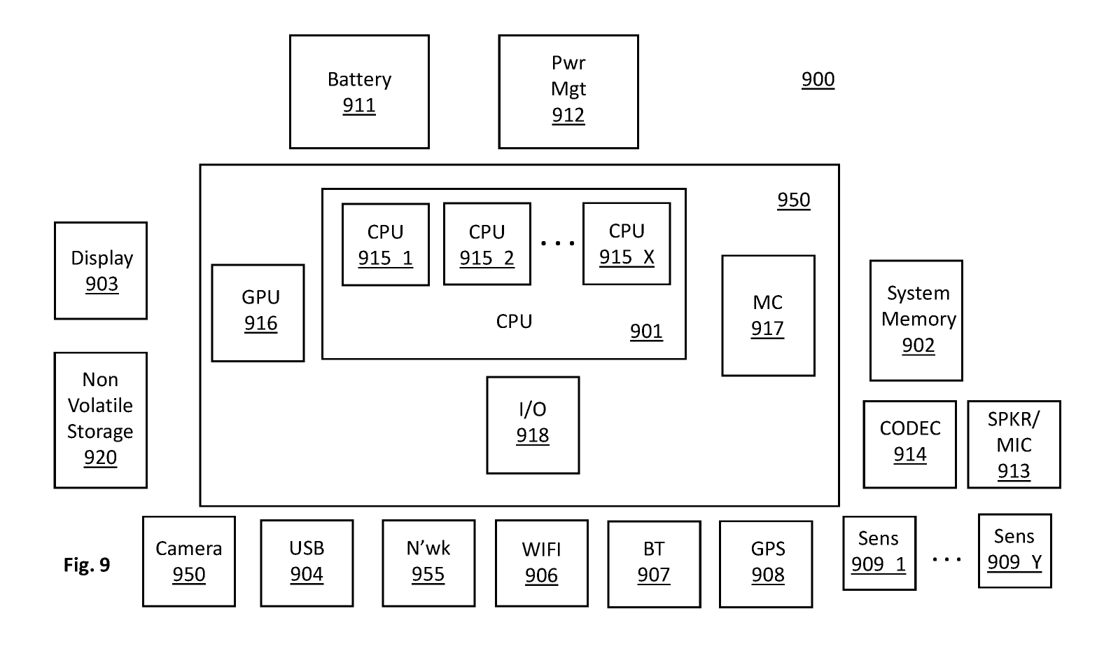

The teachings above may be applied to a computing system (a computer). FIG. 9 provides an exemplary depiction of a computing system 900 (e.g., a smartphone, a tablet computer, a laptop computer, a desktop computer, a server computer, etc.). As observed in FIG. 9, the basic computing system 900 may include a central processing unit 901 (which may include, e.g., a plurality of general purpose processing cores 915_1 through 915_X) and a main memory controller 917 disposed on a multi-core processor or applications processor, system memory 902, a display 903 (e.g., touchscreen, flat-panel), a local wired point-to-point link (e.g., USB) interface 904, various network I/O functions 905 (such as an Ethernet interface and/or cellular modem subsystem), a wireless local area network (e.g., WiFi) interface 906, a wireless point-to-point link (e.g., Bluetooth) interface 907 and a Global Positioning System interface 908, various sensors 909_1 through 909_Y, one or more cameras 910, a battery 911, a power management control unit 912, a speaker and microphone 913 and an audio coder/decoder 914.

An applications processor or multi-core processor 950 may include one or more general purpose processing cores 915 within its CPU 901, one or more graphical processing units 916, a memory management function 917 (e.g., a memory controller) and an I/O control function 918. The general purpose processing cores 915 typically execute the operating system and application software of the computing system. The graphics processing unit 916 typically executes graphics intensive functions to, e.g., generate graphics information that is presented on the display 903. The memory control function 917 interfaces with the system memory 902 to write/read data to/from system memory 902. Here, the memory control function may be implemented with a switching layer that stands between a memory controller and one or more CPUs (including being coupled to a second network that the one or more CPUs are coupled to).

The power management control unit 912 generally controls the power consumption of the system 900. Each of the touchscreen display 903, the communication interfaces 904-507, the GPS interface 908, the sensors 909, the camera(s) 910, and the speaker/microphone codec 913, 914 all can be viewed as various forms of I/O (input and/or output) relative to the overall computing system including, where appropriate, an integrated peripheral device as well (e.g., the one or more cameras 910). Depending on implementation, various ones of these I/O components may be integrated on the applications processor/multi-core processor 950 or may be located off the die or outside the package of the applications processor/multi-core processor 950. The computing system also includes non-volatile storage 920 which may be the mass storage component of the system.

Embodiments of the invention may include various processes as set forth above. The processes may be embodied in machine-executable instructions. The instructions can be used to cause a general-purpose or special-purpose processor to perform certain processes. Alternatively, these processes may be performed by specific/custom hardware components that contain hardwired logic circuitry or programmable logic circuitry (e.g., field programmable gate array (FPGA), programmable logic device (PLD)) for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a memory module, comprising:
a first command address channel input;
a first data bus input;
a second command address channel input;
a second data bus input;
a first rank of memory;
a second rank of memory;
first switch circuitry between the first and second command address channel inputs and the first and second ranks of memory, the first switch circuitry to couple command and address signals of the first and second command address channels to the first and second ranks of memory;
second switch circuitry between the first and second data bus inputs and the first and second ranks of memory, the second switch circuitry to couple data signals of the first and second data busses to the first and second ranks of memory.

2. The apparatus of claim 1 wherein at least one of the first and second ranks of memory is comprised of DRAM memory.

3. The apparatus of claim 1 wherein at least one of the first and second ranks of memory is comprised of non volatile random access memory.

4. The apparatus of claim 1 wherein the memory module further comprises a first redriver circuit coupled to the first switch circuitry to redrive command and address signals of one of the first and second command address channels off the DIMM onto a back end command address channel.

5. The apparatus of claim 4 wherein the memory module further comprises a second redriver circuit coupled to the second switch circuitry to redrive data signals of one of the first and second data busses off the memory module onto a back end data bus.

6. The apparatus of claim 1 wherein the first switch circuitry is to dynamically switch command and address signals from one of the first and second command address channels to the first and second ranks of memory.

7. The apparatus of claim 6 wherein the second switch circuitry is to dynamically switch data signals from one of the first and second data busses to the first and second ranks of memory.

8. A computing system, comprising:
a memory controller comprising a double data rate memory interface, the double data rate memory interface comprising a first memory channel interface and a second memory channel interface;
a first DIMM slot;
a second DIMM slot;
a first memory channel coupled to the first memory channel interface and the first DIMM slot, wherein the first memory channel's CA and DQ wires are not coupled to the second DIMM slot;
a second memory channel coupled to the second memory channel interface and the second DIMM slot, wherein the second memory channel's CA and DQ wires are not coupled to the first DIMM slot;
a back end memory channel that is coupled to the first and second DIMM slots.

9. The computing system of claim 1 wherein the first DIMM slot has a dummy card plugged therein comprising re-driver circuitry to redrive signals from the first memory channel onto the back end memory channel and to the second DIMM slot.

10. The computing system of claim 9 wherein the second DIMM slot has a DRAM DIMM plugged therein.

11. The computing system of claim 9 wherein the first DIMM slot has an NVRAM DIMM plugged therein.

12. The computing system of claim 1 wherein the first DIMM slot has a first DIMM plugged therein and the second DIMM slot has a second DIMM plugged therein, the first DIMM comprising multiple memory ranks, the second DIMM comprising multiple memory ranks.

13. The computing system of claim 12 wherein the memory controller is to access the multiple memory ranks of the first DIMM over the first memory channel and is to access the multiple memory ranks of the second DIMM over the second memory channel.

14. The computing system of claim 13 wherein the memory controller is also to opportunistically access the multiple memory ranks of the second DIMM over the first memory channel and the back-end memory channel.

15. The computing system of claim 14 wherein the first DIMM is an NVRAM DIMM and the second DIMM is a DRAM DIMM.

16. An apparatus, comprising:
a memory controller comprising a double data rate memory interface, the double data rate memory interface comprising a first memory channel interface and a second memory channel interface, the memory controller to only access a first memory module's memory ranks over the first memory channel and to primarily access a second memory module's memory ranks over the second memory channel, the memory controller comprising logic circuitry to opportunistically access the second memory module's memory ranks over the first memory channel and a back-end memory channel that exists between the first memory module's memory module slot and the second memory module's memory module slot.

17. The apparatus of claim 16 wherein the logic circuitry is to recognize an access opportunity to the second memory module's memory ranks over the first memory channel and the back-end memory channel when the first memory module does not have any read responses to send and cannot entertain any additional write requests.

18. The apparatus of claim 16 wherein the memory controller comprises logic circuitry to avoid simultaneously targeting a same rank on the second memory module over the first and second memory channels.

19. The apparatus of claim 16 wherein the double data rate memory interface is a DDR5 memory interface.

20. The apparatus of claim 16 wherein the first memory module is an NVRAM memory module and the second memory module is a DRAM memory module.
